(19) United States
(12) Patent Application Publication
(10) Pub. No.: US 2012/0215346 A1
(43) Pub. Date: Aug. 23, 2012

(54) BIKE LOCKING SYSTEM AND METHOD

(76) Inventors: Robert G. Gingher, West Islip, NY (US); Chad Tepper, New York, NY (US)

(21) Appl. No.: 13/402,478

(22) Filed: Feb. 22, 2012

Related U.S. Application Data
(60) Provisional application No. 61/445,284, filed on Feb. 22, 2011.

(51) Int. Cl. G06F 17/00

(52) U.S. Cl. 700/237

(57) ABSTRACT

An automatic parking station for bicycles is disclosed comprising at least one interactive workstation and a plurality of parking slots, in which parking stations are installed in a plurality of sites within a city or a limited geographical area and are electronically tied together through an interactive networked computing system. The station features countermeasures to prevent vandalism of the locked bicycle. The computing system provides the ability for users to reserve spaces and directs users to their reserved space.

### CROSS REFERENCE TO RELATED APPLICATIONS

This application claims the benefit of U.S. Provisional Patent Application Ser. No. 61/445,285, filed Feb. 22, 2011, entitled BIKE LOCKING STATION, incorporated by reference herein.

### FIELD OF THE INVENTION

The present invention relates generally to the field of securing movable goods in a variety of locations in a metropolitan, campus, or other proximal locations. In particular, the invention refers to an automatic parking station for cycles or bicycles, comprising at least one interactive workstation and a plurality of parking slots, in which parking stations are installed in a plurality of sites within a city or a limited geographical area and are electronically tied together through an interactive networked computing system.

### BACKGROUND OF THE INVENTION

Statistics show that in many countries the fleet of cycles and bicycles owned by individual persons are relevant figures. To give some examples, in Italy and France the number of cycles and bicycles that are property of individual citizens amounts to more than 20 million in each country, meaning that there is one cycle or bicycle per 3.5 persons. Similar situations can be found, with some variations, in other countries such as Spain, United Kingdom and Germany. In the Netherlands, there is more than one cycle or bicycle per person.

According to the United States Census Bureau, there are over 8,000,000 people who call New York City their home. Of these 8,000,000 people, approximately one half of one percent utilize bicycles as a means of commuting around the city on a regular basis. This percentage is even lower if you count the numerous commuters and tourists who travel into New York City from the surrounding suburbs and elsewhere to work and play. Based on these figures, the New York City bicycle commuter market has a vast number of bicyclists. There is an increasingly growing wave of New York City's pro-bicyclist policies, including the enactment of recent laws compelling New York City parking garages, commercial buildings and certain residential buildings to designate spaces exclusively for bicycle parking and the installment of miles of newly created bicycle lanes throughout New York City. This immense fleet of privately-owned cycles and bicycles cannot be ignored when an automatic parking station is built for cycles and bicycles.

Automatic parking stations for cycles and bicycles installed in diverse sites within a city and connected via a centralized information system are generally known. For instance, U.S. Patent Application Publication Nos. 2007/0220933 (Gagosz) and US 2007/0239465 (Le Gars) disclose apparatuses for automatically renting bicycles. U.S. Patent Application Publication No. 2010/0245128 (Kanof) discloses an apparatus with unique identification tags for each bicycle that use its parking system.

The above prior art apparatuses suffer from some drawbacks, among which the most relevant one includes the fact that they are either closed systems, which are not suitable to serve a plurality of different users and operators, or provide little or no protection to the bicycle parked at the station in general, and to the wheels in particular.

### BRIEF SUMMARY OF THE INVENTION

In one aspect, the present invention is directed to a system to secure a movable good, comprising: a plurality of securing units, each securing unit comprising: a shroud adapted to obstruct access to some or all of the movable good when the movable good is inserted into the shroud; and a first engaging mechanism within the shroud having a locked state and an unlocked state that, when locked, prevents the movable good from being moved; a server computer connected to a data network, comprising a web site; and a computing device that controls the state of the engaging mechanism and is communicably coupled to the server computer; wherein the server computer loads and runs a computer program into a memory of the server computer that causes the server computer to: receive identifying data from the user; verify the identity of the user based on the identifying data; determine whether the verified user has secured a movable good with the system; send a message to the computing device to unlock the engaging mechanism associated with the secured movable good; send a message to the computing device to indicate which securing unit should be used to secure the movable good; and send a message to the computing device to lock the first engaging mechanism associated with the indicated securing unit.

In another aspect, the system further comprises a data input interface connected to the server computer that receives identifying data from a user that uniquely identifies the user. In yet another aspect of the present invention, the data input interface comprises a smart phone, a laptop or a tablet computer connected to the server computer through the Internet. In yet another aspect, the server computer is further adapted to indicate a location of a plurality of securing units having at least one securing unit in which a movable good may be secured therewith to the user.

In another aspect of the present invention, the server computer is further adapted to reserve a securing unit in the plurality in response to a message from the user. In another aspect, the server computer is further adapted to select the location from a database based on least distance to a destination received from the user. In another aspect, the server computer is further adapted to hold the reservation for a limited period of time, based on a current position of the user and the estimated time to travel to the location.

In another aspect, the system further comprises a track adapted to guide the insertion and removal of the movable good into and out of the shroud.

In another aspect, the system further comprises a tamper sensor that provides a signal to the computing device indicating attempted movement of the secured movable good. In another aspect of the present invention, the computing device sends a warning message to the server computer in response to receiving the signal from the tamper sensor, and the server computer is further adapted to send a message to the user in response to the warning message from the computing device.

In another aspect, the present invention further comprises a video camera adapted to transmit an image of the plurality of securing units to the computing device and wherein the server computer is adapted to provide the image to a user having locked a movable good in one of the securing units within said plurality. In another aspect, the present invention further comprises a moving barrier, and wherein the first engaging mechanism engages the moving barrier, and wherein the shroud and the moving barrier, when engaged, together prevents a part of the movable good within the moving barrier and shroud from being removed.

In an alternative aspect, the present invention further comprises a ring attached to the movable good and wherein the first engaging mechanism engages the ring.

In another aspect, the present invention further comprises a second engaging mechanism without the shroud having a locked state and an unlocked state that, when locked, comes in contact with the movable good and prevents movement of the movable good and wherein the computing device is further adapted to lock and unlock the second engaging mechanism.

In another aspect, the present invention further comprises a third engaging mechanism without the shroud having a locked state and an unlocked state that, when locked, comes in contact with another movable good associated with the movable good, wherein the third engaging mechanism prevents movement of the another movable good, and wherein the computing device is further adapted to lock and unlock the third engaging mechanism.

### BRIEF DESCRIPTION OF THE DRAWINGS

FIG. 1 is a block diagram that illustrates a computer architecture of a preferred embodiment of the present invention;

FIG. 2 is a flow chart that illustrates steps taken by a control program implementing a reservation system;

FIG. 3 is a block diagram that illustrates various computer-readable media used to store the control program for a control website;

FIG. 4 is a top view diagram of an exemplary bike rack;

FIG. 5 is a perspective view diagram of a parking slot in a bike rack;

FIGS. 6 and 7 are side view diagrams respectively illustrating a front wheel locking mechanism embodiment of the present invention;

FIGS. 8 and 9 are top view diagrams illustrating an alternative front wheel locking mechanism embodiment of the present invention;

FIG. 10 illustrates another exemplary embodiment of a front wheel locking mechanism for the present invention; and

FIG. 11 illustrates an exemplary embodiment of a rear wheel locking mechanism of the present invention.

### DETAILED DESCRIPTION OF THE INVENTION

It is well-known that property, if left unattended, may be subject to vandalism. Especially in New York City, where the sheer number of people provide a challenge to law enforcement to prevent such crimes. While no system is foolproof against the devious nature of the criminal mind, measures can be taken to make such minor and often not prosecuted crimes such as theft and vandalism more difficult to commit. The present invention strives to do just that, in the context of providing a safe, economical and convenient means for bicycle parking.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, Visual Basic, Python, CGI, PHP or the like, with the various algorithms being implemented with any combination of data structures, objects, processes, routines or other programming elements. The object code created for the computers can preferably be executed by any general purpose computer such as a personal computer having an appropriate operating system such as Windows™ or MAC™ and an appropriate browser such as Internet Explorer,™ Netscape™ or Safari.™

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

Data Processing Architecture

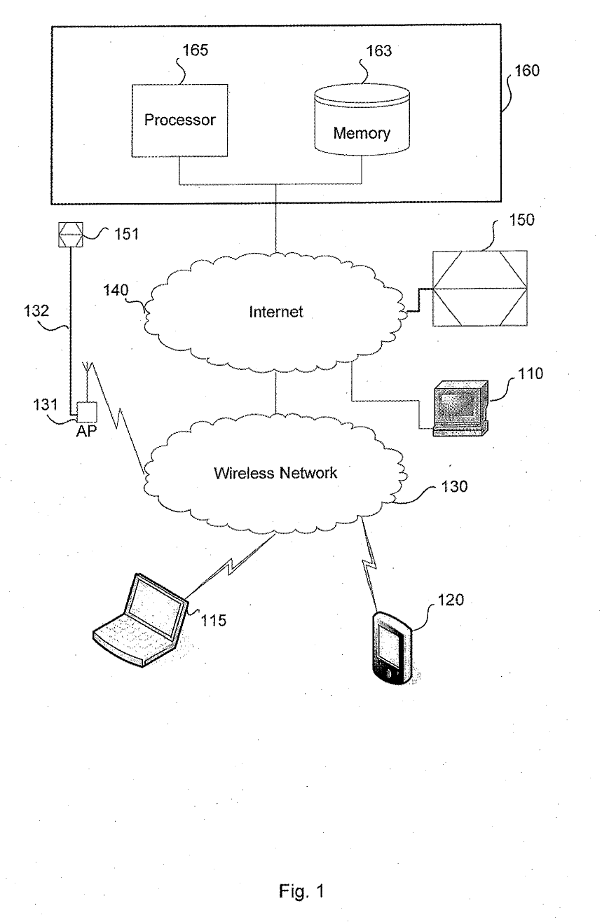

FIG. 1 is a block diagram that illustrates a computer architecture of a preferred embodiment of the present invention. In a preferred embodiment, the system and method of the present invention are directed to a computing device at a parking station in communication with a server through the Internet. FIG. 1 discloses a wireless network 130 that provides data communications to mobile devices such as a laptop 115 or handheld cellular device 120, as well as data connectivity to access points 131. Bicycle racks 150 and 151 communicate through either wireless network 130 or the Internet 140 to a central server computer 160. In more detail, with reference to FIG. 1, because Internet 140 can provide a data communication path between various mobile computing platforms, such as a laptop 115 or a PDA or cellular telephone 120 provided through a wireless network 130 to the Internet 140, a user is not limited to a desktop 110 with Internet connectivity to make a reservation, check the status of their bike, or receive messages concerning their bike from the central control website 160. Bike racks 150, 151 operate under the control of server computer 160. As wired Internet connectivity may not be available to each bike rack, a rack 151 may be connected through a local area network 132 and a wireless access point 131.

The server computer 160 comprises a memory 163 and a processor 165 that receives and processes users' reservation requests and maintains the status of each parking slot on bicycle racks 150, 151 located throughout the network. In a preferred embodiment, software on desktop computer 110, laptop 155 or handheld device 120 (collectively, the “client device”) comprises a Web browser, such as Internet Explorer,™ Netscape,™ Firefox,™ Safari™ or other Web browser, or a web-based application program pre-loaded into memory of the client device or is readily-available for download from the Internet into the memory. Such browsers or applications retrieve Web pages or data from a Web server 160 using the hyper-text transfer protocol (HTTP) in response to inputs on a user interface of the client device. Web pages are loaded into memory and then rendered on the display of the client device. In an alternative embodiment, a dedicated, client-based application is installed on client device, wherein such client-based application may use alternate communication protocols from HTTP.

Software on server computer 160 preferably comprises a Web server application. Web server application listens for TCP/IP (transport control protocol/Internet protocol) connections on a well-known port and receives standard HTTP (hyper-text transfer protocol) requests on that port that identifies particular URL (universal resource locator) that indicates Web pages and other information requested, typically by Web browser on the client device. Preferably, a Web server application comprises Apache and a collection of software modules that generate HTML (hyper-text markup language) Web pages.

In addition, server computer 160 may include a database stored in memory 163 that includes information related to the physical configuration and status of bicycle parking racks 150, 151, users, directions, locations, time and reservations. A database server application is run by processor 165, is coupled to the database, and provides an interface to the information stored in the database to other application software modules that execute on server computer 160. In a preferred embodiment, the database is a relational database, which includes a number of interrelated tables. Database server application is preferably an SQL (structured query language) server that accepts queries according to an SQL syntax and provides responses to those queries. Database server application can perform stored database procedures comprising complex queries stored in SQL syntax on server computer 160. Such queries may involve multiple fetching processes from more than one table in the tables that comprise the database. Stored database procedures are stored in a file system in the memory 163 of server computer 160.

Although FIG. 1 illustrates only one server computer 160 and a few client devices 110, 115, 120 in communication through networks 130, 140, it should be understood that different numbers of computers may be utilized, at the very least, one client device per user. In one example, the networks 130, 140 may include a plurality of network computers and tens or hundreds of computers, all of which may be interconnected via the networks 130, 140. In alternate embodiments, the functions performed by server computer 160 are split among several server computers, for example, having components of Web server application executed on computers different from a database server application. Furthermore, these servers may be geographically separated and, for example, coupled through Internet 140. In a preferred embodiment, a plurality of client devices are able to simultaneously connect to the server computer 160. The communication links may be provided as a dedicated hardwired link or a wireless link. Although the communication links are illustrated as a single data link, they may comprise multiple data links.

The networked computers, client computer 110 and server computer 160, may be provided in many different geographic locations including a home, different areas of the same city, or they may be located in different states or even countries. Networks 130, 140 may include a plurality of network computers or server computers (not shown), each of which may be operatively interconnected. Where network 140 comprises the Internet, data communication may take place over communication links via an Internet communication protocol (UDP/IP or TCP/IP). Where the network 130 comprises a wireless network, data communication may take place over communication links via a wireless data protocol such as CDMA2000, W-CDMA or other 3G, 4G cellular or wifi technologies. Similarly, where the network communications comprise data, voice and video, communication may take place via an Internet communication protocol or a wireless protocol.

System Operation

The following discussion describes the methods performed by the inventive system. To provide context, the operation of an exemplary, preferred embodiment of a Web-based client/server application and a database server application are described. The description is based on that actions that the computers will perform when the applications are loaded and run.

Web pages served by server computer 160 may comprise at least two types of pages. One type are static Web pages, that are HTML format pages passed on by client/server application direct to a requesting Web browser without modification. The other type are dynamic or active server pages. An active server page includes a procedure specification that, when requested by a Web browser, is executed under the control of client/server application rather than being directly passed to the Web browser. Execution of the procedure specified by an active server page produces HTML formatted information that is passed by client/server application to a Web browser. In a preferred embodiment, active server pages can be generated by a Visual Basic language procedure, CGI scripts, or a procedure written in some other programming or scripting language such as java, perl, python or php, that are executed under the control of a client/server application running on server computer 160.

Active server pages can include references to services provide by a database server application. For instance, a Visual Basic procedure in active server page accesses database server application through an API (application program interface) for the database server application. During execution of the stored procedure, client/server application can access data stored in a database in memory 163. Active server pages can also include references to database procedures stored in memory 163. Each stored database procedure includes one or more SQL statements. Client/server application invokes a stored database procedure during execution of an active server page. Database server application controls the execution of stored database procedure to provide data to client/server application. Together, static Web pages, active server pages, and stored database procedures provide the information to generate Web pages through which a user interacts with the system. Alternatively, a dedicated, client-based application can interact with server application directly, without use of a Web browser.

A database in memory 163 may include a number of separate tables. For example, a rack configuration table includes information related to the geographic location of each rack, the number of slots in each rack, and of those slots, which slots are occupied, which are available, and which are reserved. Like all tables in a database, the rack configuration table is dynamic in that it can be modified, for example, as more racks are added or removed from the system, more slots are added or removed from each rack, or when the status of each slot changes.

A database in memory 163 may also include a user table that includes information about the user, such as user authentication information, usage information, addresses, destinations, favorites, billing information or the like.

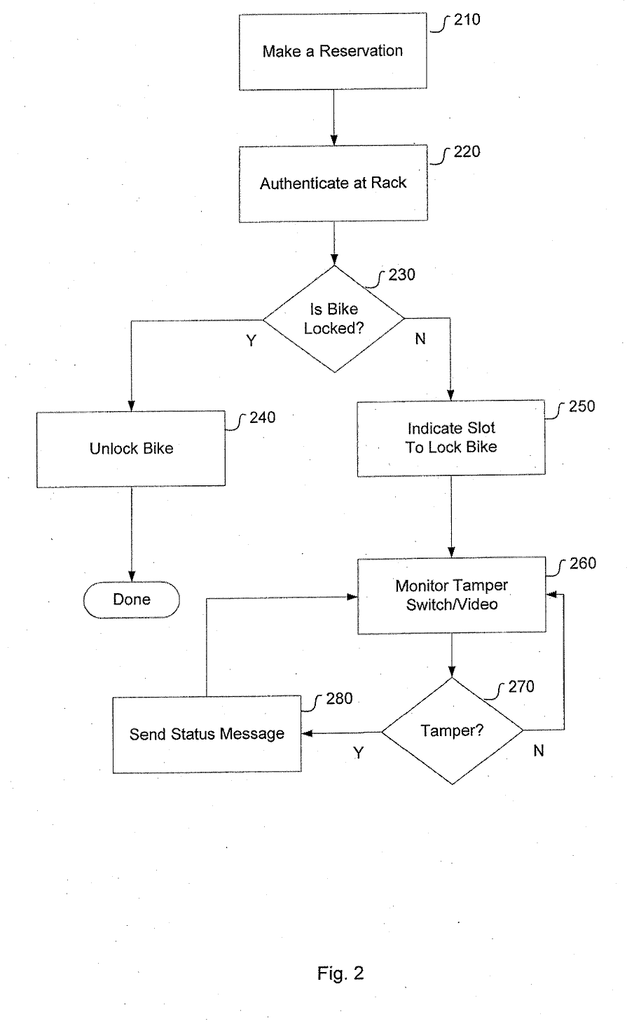

FIG. 2 is a flow chart that illustrates a preferred method for the various steps taken by a client/server application that is loaded from memory 163 and run by processor 165 in server computer 160. As shown in FIG. 2, in step 210 a user makes a reservation by operation of client device 110, 115, 120 to send a message to the server computer 160. Preferably, server computer 160 will reserve an available slot in a bike rack 150, 151 chosen by the user, and will hold the reservation for a limited period of time. More preferably, the period of time will be based on the location of the user, the location of the rack, and the expected time for the user to ride to the rack. Server computer 160 may reserve an available slot in an alternative bike rack if there are no available slots in the bike rack chosen by the user. In a preferred embodiment, server computer 160 will find an available slot in the nearest bike rack to the user's ultimate destination, to minimize the amount of walking distance that the user may have to traverse. Server computer 160 may even provide directions to the user to the rack in which a slot has been reserved.

In step 220, the user arrives with his bicycle at a rack 150, 151 where a slot has been held for him by the reservation. The user then supplies credentials to authenticate his identity at the rack 150, 151. Such authentication can take the form of a credit card swipe, a bar code read, entry of a personal identification number, facial recognition, communication of a unique identifier found in client device, such as MAC address, bluetooth ID, or the like, as is well-known in the art. In an alternative embodiment, the user may arrive at a rack 150, 151 without a reservation, and then authenticate.

In step 230, server computer 160 receives the authentication credentials, verifies the identity of the user, and checks the database stored in memory 163 to see if the user's bike is currently locked in a rack or not. If the bike is locked in a rack, processing proceeds to step 240, where the server computer sends a message to the rack 150, 151, directing the rack to unlock the user's bike.

If the bike is not locked, then processing proceeds to step 250, where server computer 160 commands the rack to indicate which slot the user should place his bike. The user then rolls his bike into the rack thereby securely locking the bike in the rack, preferably using one of the mechanisms described below.

In step 260, the rack continually monitors a tamper sensor for the bike, and may also stream video back to server computer 160 continuously, or in the event of a tamper sensor activation.

In step 270, if a tamper event has occurred, the rack 150, 151 will notify server computer 160 of the event, which in turn may send a warning message to the corresponding user, as shown in step 280. The user may then monitor the video feed via the website provided by server computer 160.

Software on Media

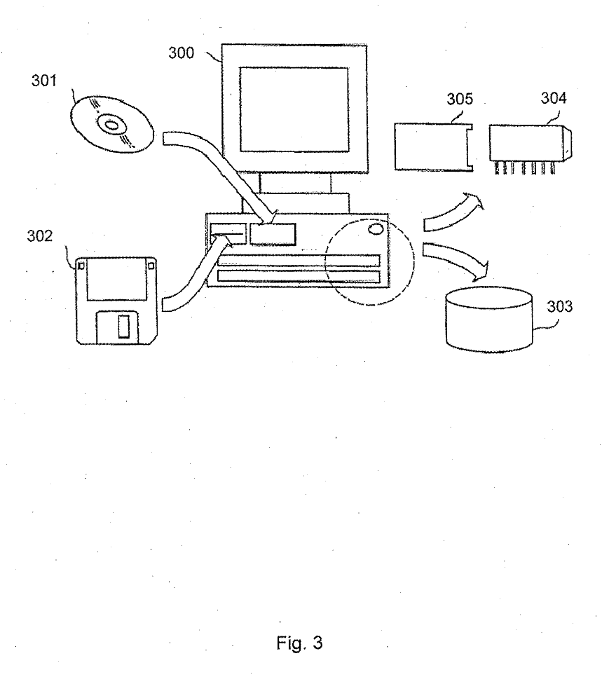

In the specification, the term “media” means any computer-readable medium that can record data therein. FIG. 3 illustrates examples of recordable computer-readable media.

The term “media” includes, for instance, a disk shaped media for 301 such as CD-ROM (compact disc-read only memory), magneto optical disc or MO, digital video disc-read only memory or DVD-ROM, digital video disc-random access memory or DVD-RAM, a floppy disc 302, a memory chip 304 such as random access memory or RAM, read only memory or ROM, erasable programmable read only memory or E-PROM, electrical erasable programmable read only memory or EE-PROM, a rewriteable card-type read only memory 305 such as a smart card, a magnetic tape, a non-volatile memory, also known as a hard disc 303, and any other suitable means for storing a program therein.

A recording media storing a program for accomplishing the above mentioned apparatus may be accomplished by programming functions of the above mentioned apparatuses with a programming language readable by a computer 300 or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer 300, any suitable device for performing computations in accordance with a computer program may be used. Examples of such devices include a server, a personal computer, a laptop computer, a net-top computer, a microprocessor, a programmable logic device, or an application specific integrated circuit.

Hardware Architecture

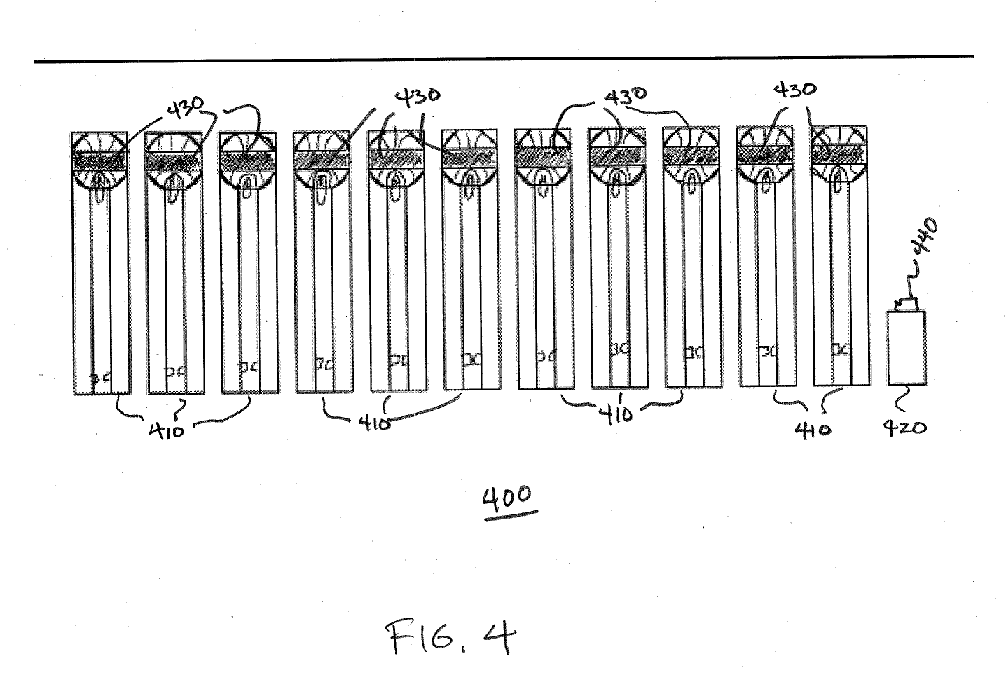

FIG. 4 is a top view diagram of an exemplary bike rack. With reference to FIG. 4, a bike rack 400 comprises a plurality of parking slots 410 and a computing device 420 for communicating with server computer 160, receiving authentication data and supplying signals to lock/unlock each of the parking slots, and to provide indications 430 as to the status of the parking slots. A camera 440 is communicatively coupled to computing device 420. Bike rack 400 may contain a URL or a bar code providing Web navigation for a user of a handheld client device to interact with the server computer 160, so that a user interface to computing device 420 will not be required. Computing device 420 may interface with a card reading device for payment by credit card, debit card, smart card or a discount card, bar code reader, or the like well-know in the art to allow the system to provide user access and payment for parking privately owned bicycles, or rent bicycles parked in the slots for that purpose. Discount cards may include cards provided by local merchants as a perk to their customers, similar to validated automobile parking.

The user will be able to view streaming, up-to-the-second video of their secure bicycle through protected camera 440 that is integrated into the bike rack 400. Access to such streaming video will only be permitted to users who currently have their bike parked in the corresponding bike rack. In a preferred embodiment, server computer 160 may provide an application for download that will allow users to record and store images of parked bicycles in their client device 110, 115, 120.

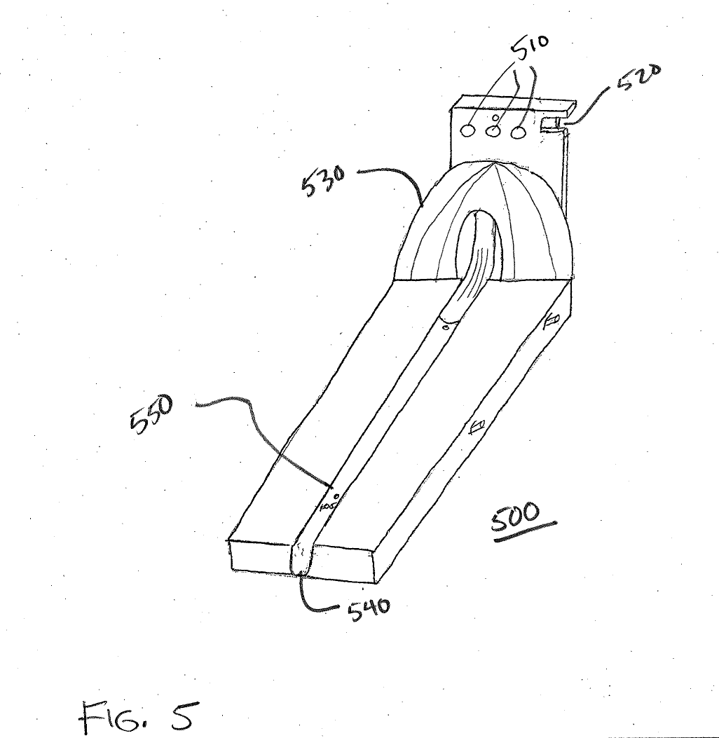

FIG. 5 is a perspective view diagram of a parking slot 500 in a bike rack 400. Illustrated in FIG. 5 are indicators 510, helmet lock 520, shroud 530, track 540, and tamper sensor 550. Indicators 510 may include: (i) a green light indicates that such parking slot is available for parking, (ii) a yellow light that indicates the parking slot is reserved, (iii) a flashing yellow light that indicates that a given reservation is set to expire in a short time period, and (iv) a red light that indicates that a bicycle is currently secured in that slot.

Helmet lock 520 provides a latching mechanism to secure the user's helmet. Helmet lock 520 provides the user with the ability to slide the “Y” portion of the helmet strap in the slot (which is just wide enough to fit the size of the strap) so that the portion of the Y strap that is attached to the helmet is resting on the base of the slot. Once the bicycle is locked in the parking slot 500, a retractable pin located in the slot will deploy through the center of the portion of the Y strap that is attached to the helmet, locking the helmet's strap within the slot. The pin will retract, unlocking the Y strap from the slot when the user unlocks their bicycle from parking slot 500.

In an alternative embodiment, slot 500 may further comprise a compartment (not illustrated) where the user's helmet may be placed. Helmet lock 520 will provide access to the interior of the compartment, and can be locked and unlocked in the same fashion as described above.

Shroud 530 protects the front wheel of the bicycle, as described below. Track 540 helps the user guide the bicycle into the proper position to park and secure the bicycle.

As an additional security measure, each slot is equipped with an anti-theft tamper sensor 550 that provides a signal to the computing device 420. Tamper sensor 550 may be infrared, ultrasonic, pressure, contact, or any other device or mechanism well-known in the art to detect movement, attempted forced removal or component theft of the bicycle. Computing device 420 may, in turn, (i) instantaneously notify a garage attendant, doorman or passerby located at the site of the triggered anti-theft sensor of any unauthorized movement of a user's bicycle from its parking slot; (ii) send a notification via email to that certain user, notifying him or her that their bicycle has been tampered with; (iii) sound an audible alarm; or (iv) send a message to law enforcement authorities. Tamper sensor 550 may be so displaced as to be sensitive to movements occurring in a volume around a parking slot that is suitable to fully include one bicycle. Computing device may automatically activate or deactivate any notifications based on parking activity in an adjacent slot.

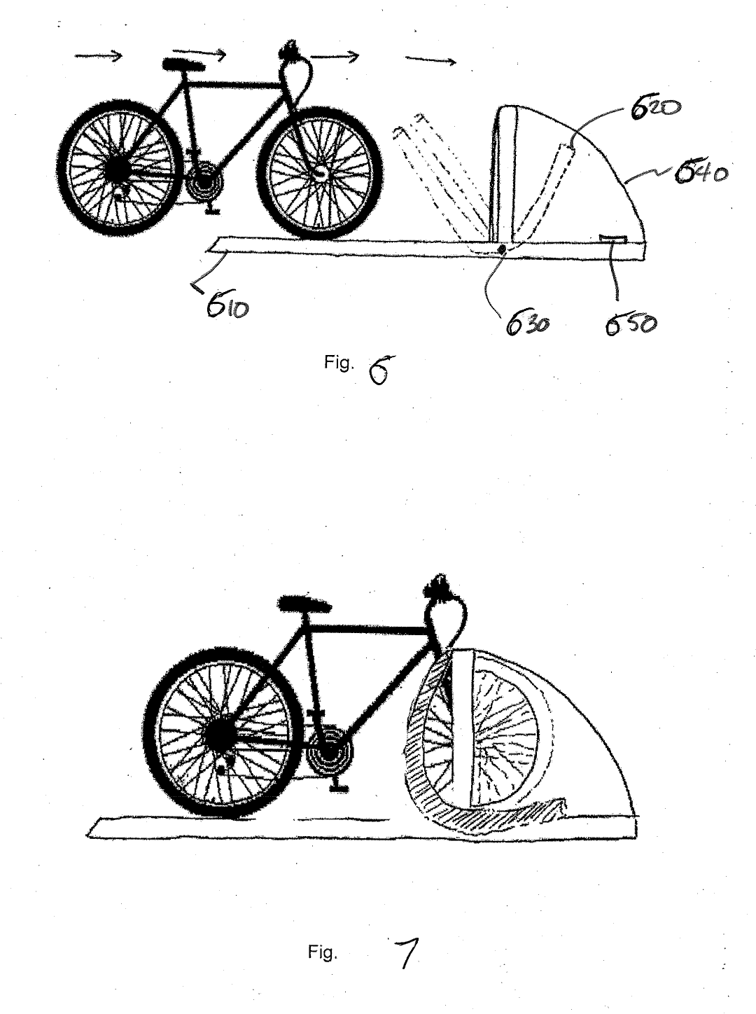

FIG. 6 is a side view diagram illustrating a front wheel locking mechanism embodiment of the present invention. FIG. 6 discloses a track 610, a boomerang-shaped lever arm 620, that pivots on a toggle bolt or shaft 630, a shroud 640, and a releasable latching mechanism 650. As shown in FIG. 4, the user can push their bicycle along track 610 such that the front wheel comes in contact with the top of boomerang 620 so that boomerang 620 pivots upward around shaft 630. As the wheel is moved into shroud 640, the back of boomerang 620 is designed to capture the rear of the front bike tire, thereby preventing the bike from being removed from shroud 640. When the front wheel is fully inserted, the front of boomerang 620 will engage latching mechanism 650, thereby preventing boomerang 620 from pivoting, as illustrated in side view diagram, FIG. 7. Boomerang 620, in cooperation with shroud 640, encapsulates the front tire and forks of the user's bike. When the bike is unlocked, latching mechanism 650 releases boomerang 620 to permit the user to withdraw his bike from shroud 640 along track 610.

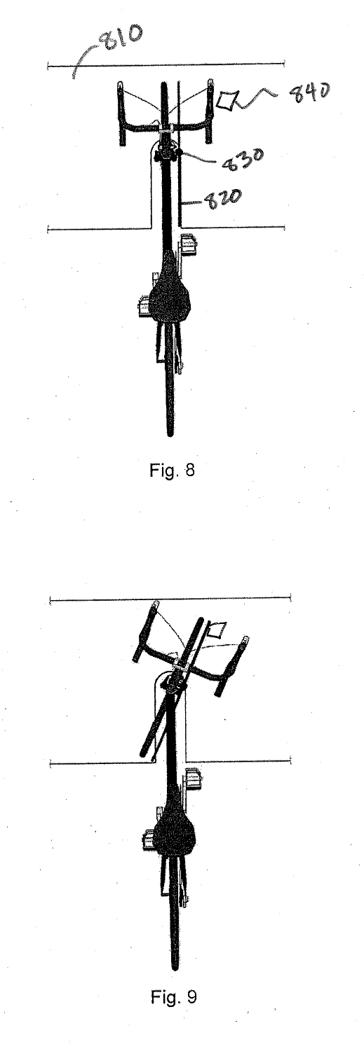

FIGS. 8 and 9 are top view diagrams illustrating another locking mechanism embodiment of the present invention. FIG. 8 illustrates a shroud 810, blocking plate 820, pivot 830, and latch 840. Blocking plate 820 is attached to pivot 830, and rotates within shroud 810 about the axis of pivot 830. Latch 840 comprises a magnetic lock or other electro-mechanically release mechanism that connects to blocking plate 820, and securely prevents blocking plate from counter-rotation until unlocked.

In operation, the user pushes their bicycle on a track such as described above, allowing the front wheel to enter shroud 810. Once the front tire of the bicycle is fully inserted into shroud 810, the user will turn the wheel of the bicycle, which will rotate blocking plate 820. Latch 840 latches onto blocking plate 820, thereby encapsulating front tire within the shroud and preventing rotation of the front wheel from the locked position, as illustrated in FIG. 9.

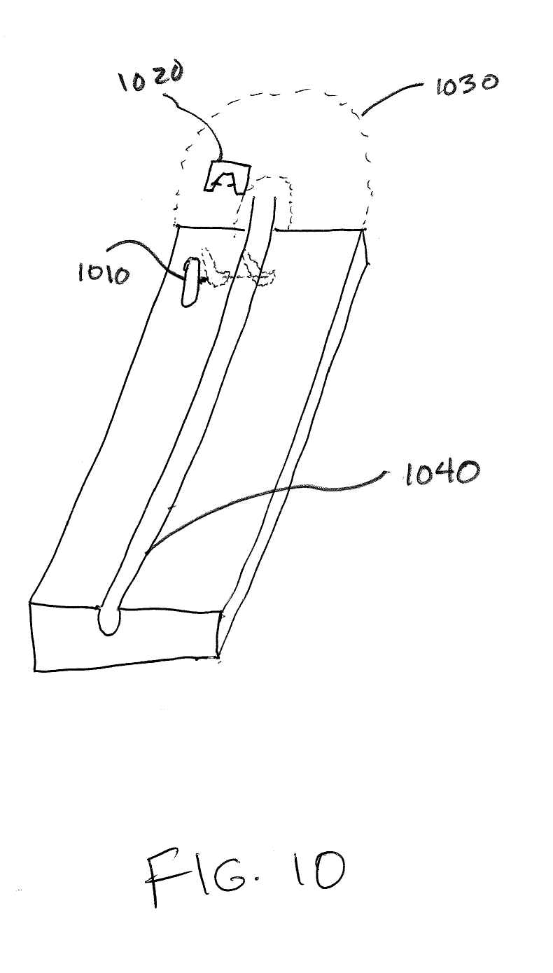

FIG. 10 illustrates another exemplary embodiment of a front wheel locking mechanism for the present invention, comprising a ring 1010 and a latching mechanism 1020. Ring 1010 is preferably mechanically secured at a predetermined height above the ground to the front fork of a bicycle. Such securing can be accomplished with materials commonly known in the art, such as a pipe clamp and a fastener, welding, or the like. Latching mechanism 1020, located within shroud 1030, engages ring 1010 the user guides bicycle along track 1040, and prevents the removal of the bicycle until latching mechanism 1020 is unlocked, as described above.

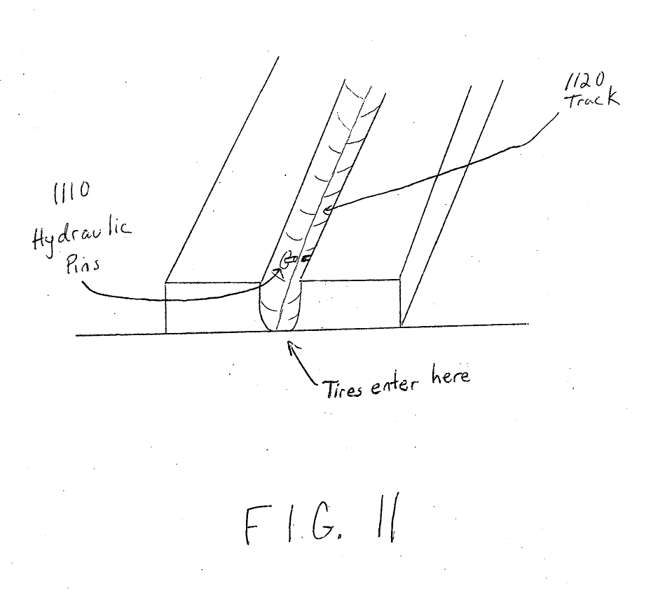

FIG. 11 illustrates an exemplary embodiment of a rear wheel locking mechanism for the present invention. FIG. 11 illustrates a plurality of hydraulic pins 1110 and a track 1120. Track 1120 is similar to track 610 described above. When the user engages the front wheel locking mechanism of the present invention, hydraulic pins 1110 are advanced to block the rear tire of the bicycle from moving out of the track or passing beyond hydraulic pins 1110. When the user unlocks the bicycle, hydraulic pins 1110 retract, thereby releasing the rear tire.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. A system to secure a movable good, comprising:
a plurality of securing units, each securing unit comprising:
a shroud adapted to obstruct access to some or all of the movable good when the movable good is inserted into the shroud; and
a first engaging mechanism within the shroud having a locked state and an unlocked state that, when locked, prevents the movable good from being moved;
a server computer connected to a data network, comprising a web site; and
a computing device that controls the state of the engaging mechanism and is communicably coupled to the server computer;
wherein the server computer loads and runs a computer program into a memory of the server computer that causes the server computer to:
receive identifying data from the user;
verify the identity of the user based on the identifying data;
determine whether the verified user has secured a movable good with the system;
send a message to the computing device to unlock the engaging mechanism associated with the secured movable good;
send a message to the computing device to indicate which securing unit should be used to secure the movable good; and
send a message to the computing device to lock the first engaging mechanism associated with the indicated securing unit.

2. The system of claim 1, further comprising: a data input interface connected to the server computer that receives identifying data from a user that uniquely identifies the user.

3. The system of claim 2, wherein the data input interface comprises a smart phone, a laptop or a tablet computer connected to the server computer through the Internet.

4. The system of claim 3, wherein the server computer is further adapted to indicate a location of a plurality of securing units having at least one securing unit in which a movable good may be secured therewith to the user.

5. The system of claim 4, wherein the server computer is further adapted to reserve a securing unit in the plurality in response to a message from the user.

6. The system of claim 5, wherein the server computer is further adapted to select the location from a database based on least distance to a destination received from the user.

7. The system of claim 6, wherein the server computer is further adapted to hold the reservation for a limited period of time, based on a current position of the user and the estimated time to travel to the location.

8. The system of claim 7, further comprising a track adapted to guide the insertion and removal of the movable good into and out of the shroud.

9. The system of claim 8, further comprising a tamper sensor that provides a signal to the computing device indicating attempted movement of the secured movable good.

10. The system of claim 9, wherein the computing device sends a warning message to the server computer in response to receiving the signal from the tamper sensor, and the server computer is further adapted to send a message to the user in response to the warning message from the computing device.

11. The system of claim 10, further comprising a video camera adapted to transmit an image of the plurality of securing units to the computing device and wherein the server computer is adapted to provide the image to a user having locked a movable good in one of the securing units within said plurality.

12. The system of claim 11, further comprising a moving barrier, and wherein the first engaging mechanism engages the moving barrier, and wherein the shroud and the moving barrier, when engaged, together prevents a part of the movable good within the moving barrier and shroud from being removed.

13. The system of claim 12, further comprising a ring attached to the movable good and wherein the first engaging mechanism engages the ring.

14. The system of claim 13, further comprising: a second engaging mechanism without the shroud having a locked state and an unlocked state that, when locked, comes in contact with the movable good and prevents movement of the movable good and wherein the computing device is further adapted to lock and unlock the second engaging mechanism.

15. The system of claim 14, further comprising a third engaging mechanism without the shroud having a locked state and an unlocked state that, when locked, comes in contact with another movable good associated with the movable good, wherein the third engaging mechanism prevents movement of the another movable good, and wherein the computing device is further adapted to lock and unlock the third engaging mechanism.
